(19) United States
(12) Patent Application Publication
(10) Pub. No.: US 2016/0248066 A1
(43) Pub. Date: Aug. 25, 2016

(54) SEPARATORS FOR HIGH VOLTAGE RECHARGEABLE LITHIUM BATTERIES AND RELATED METHODS

(71) Applicant: Celgard, LLC, Charlotte, NC (US)

(72) Inventors: Lie Shi, Matthews, NC (US); C. Glen Wensley, Rock Hill, SC (US); Ronnie E. Smith, Huntersville, NC (US); Kwantai Cho, Charlotte, NC (US); Edward Kruger, Charlotte, NC (US)

(21) Appl. No.: 15/053,474

(22) Filed: Feb. 25, 2016

Related U.S. Application Data
(60) Provisional application No. 62/120,501, filed on Feb. 25, 2015.
(60) Provisional application No. 62/205,202, filed on Aug. 14, 2015.

(51) Int. Cl. H01M 2/16; H01M 2/34; H01M 10/0525

(52) U.S. Cl. CPC H01M 2/1686; H01M 10/0525; H01M 2/166; H01M 2/348; H01M 2200/10

(57) ABSTRACT

In accordance with at least selected embodiments, the present disclosure or invention is directed to improved or novel separators, cells, batteries, and/or methods of manufacture and/or use. In accordance with at least certain embodiments, the present disclosure or invention is directed to improved or novel separators such as a separator for a high energy and/or high voltage lithium ion battery which is stable up to a 4.5 volt, or preferably up to a 5.0 volt or higher charging voltage, such as a novel or improved single or multilayer or multiply microporous separator membrane. In accordance with at least selected embodiments, the present application or invention is directed to novel or improved porous membranes or substrates, separator membranes, separators, composites, electrochemical devices, batteries, cells, methods of making such membranes or substrates, separators, cells, and/or batteries, and/or methods of using such membranes or substrates, separators, cells, and/or batteries. In accordance with at least certain embodiments, the present application is directed to novel or improved microporous membranes, battery separator membranes, separators, energy storage devices, batteries including such separators, methods of making such membranes, separators, and/or batteries, and/or methods of using such membranes, separators and/or batteries. In accordance with at least certain selected embodiments, the present invention is directed to a novel or improved separator membrane or separator with or without embedded particles or materials, such as ceramic particles or materials, for example, aluminum oxide, boehmite, and/or barium, and/or with or without novel polymers, such as PVDF or PMP, and/or with or without one or more ceramic coatings, for a battery which is stable up to at least 5 volts in a battery, a novel or improved polymer membrane, or polymeric microporous membrane, adapted for use in a 4.5 volt, 4.7 volt, or 5 volt or higher rechargeable or secondary lithium battery and/or which provides for the energy density of a battery to be increased and/or has excellent oxidation resistance. In accordance with at least particular embodiments, the battery separator membrane described herein is directed to a single or multilayer or composite microporous membrane battery separator which may have excellent oxidation resistance and/or may be stable in a high voltage lithium battery system up to 5 volts or more.

### REFERENCE TO RELATED APPLICATIONS

This application claims the benefit of and priority to U.S. provisional patent application Ser. No. 62/120,501 filed Feb. 25, 2015, and to U.S. provisional patent application Ser. No. 62/205,202 filed Aug. 14, 2015, both of which are fully incorporated by reference herein.

### FIELD OF THE INVENTION

In accordance with at least selected embodiments, the present disclosure or invention is directed to improved or novel separators, cells, batteries, and/or methods of manufacture and/or use. In accordance with at least certain embodiments, the present disclosure or invention is directed to improved or novel separators such as a separator for a high energy and/or high voltage lithium ion battery which is stable up to a 4.5 volt, or preferably up to a 5.0 volt or higher charging voltage, such as a novel or improved single or multilayer or multiply microporous separator membrane. In accordance with at least selected embodiments, the present application or invention is directed to novel or improved porous membranes or substrates, separator membranes, separators, composites, electrochemical devices, batteries, cells, methods of making such membranes or substrates, separators, cells, and/or batteries, and/or methods of using such membranes or substrates, separators, cells, and/or batteries. In accordance with at least certain embodiments, the present application is directed to novel or improved microporous membranes, battery separator membranes, separators, energy storage devices, batteries including such separators, methods of making such membranes, separators, and/or batteries, and/or methods of using such membranes, separators and/or batteries. In accordance with at least certain selected embodiments, the present invention is directed to a novel or improved separator membrane or separator with or without embedded particles or materials, such as ceramic particles or materials, for example, aluminum oxide, boehmite, and/or barium, and/or with or without novel polymers, such as PVDF or PMP, and/or with or without one or more ceramic coatings, for a battery which is stable up to at least 5 volts in a battery, a novel or improved polymer membrane, or polymeric microporous membrane, adapted for use in a 4.5 volt, 4.7 volt, or 5 volt or higher rechargeable or secondary lithium battery and/or which provides for the energy density of a battery to be increased and/or has excellent oxidation resistance. In accordance with at least particular embodiments, the battery separator membrane described herein is directed to a single or multilayer or composite microporous membrane battery separator which may have excellent oxidation resistance and/or may be stable in a high voltage lithium battery system up to 5 volts or more.

### BACKGROUND OF THE INVENTION

Battery manufacturers in the electric vehicle industry are designing innovative battery cells with higher energy chemistries to extend the driving range of electric vehicles. The two common approaches to accomplish this goal are 1) developing new higher energy battery chemistries as a means to increase the chemical potential of a lithium ion battery, and 2), increasing the charging voltages in a lithium ion battery from the current range of 4.2 to 4.5 volts to the industry goal of a 5 volt charging voltage. Today's electric drive vehicles (EDV) use cathode materials consisting of Lithium Iron Phosphate (LiFePO₄) or Lithium Manganese Oxide (LMO). Since the overall energy density of the cells based on LiFePO₄ and LMO chemistries is relatively low, a broad range of battery separator technologies are suitable for these battery applications. Typically, the battery chemistries are stable in the range of 4.2 to 4.5 volts. The battery industry would like to increase the overall energy density of the cells. One example of a higher energy chemistry is Nickel Cobalt Aluminum (NCA), LiNi0.8Co0.15Al0.05O2, which can extend charging voltages to 5.0 volts. With a 5 volt charging voltage capability, a battery cell can be charged higher to allow for additional energy density.

Hence, there is a need for a battery separator for higher energy battery chemistries, for higher charging voltages, and/or for use in a 5 volt rechargeable lithium battery. Also, as lithium batteries are developed to operate at higher voltages, at higher charge rates, with higher energies, and/or the like, there is a need for a microporous separator membrane for a lithium ion battery that is oxidation resistant, that can function in a high energy battery, and/or that may be stable at voltages up to at least 5 volts in a high voltage battery system. Further, there is a need for a thin highly oxidation resistant microporous separator that may prevent trickle charge at high voltages up to at least 5 volts in a lithium battery.

### SUMMARY OF THE INVENTION

In accordance with at least selected embodiments, aspects or objects, the present disclosure or invention may address the above needs, may provide a battery separator for higher energy battery chemistries, for higher charging voltages, and/or for use in a 5 volt rechargeable lithium battery, may provide a microporous separator membrane for a lithium ion battery that is oxidation resistant, that can function in a high energy battery, and/or that may be stable at voltages up to at least 5 volts in a high voltage battery system, and/or may provide a thin highly oxidation resistant microporous separator that may prevent trickle charge at high voltages up to at least 5 volts in a lithium battery, and/or have oxidation stability at 5 volts for use in a lithium ion rechargeable battery.

In accordance with at least selected embodiments, aspects or objects, the present disclosure or invention may provide or be directed to improved or novel separators, cells, batteries, and/or methods of manufacture and/or use. In accordance with at least certain embodiments, the present disclosure or invention is directed to improved or novel separators such as a separator for a high energy and/or high voltage lithium ion battery which is stable up to a 4.5 volt, preferably up to a 4.7 volt, or more preferably up to a 5.0 volt or higher charging voltage, such as a novel or improved single or multilayer or multiply microporous separator membrane. In accordance with at least selected embodiments, the present application or invention is directed to novel or improved porous membranes or substrates, separator membranes, separators, composites, electrochemical devices, batteries, cells, methods of making such membranes or substrates, separators, cells, and/or batteries, and/or methods of using such membranes or substrates, separators, cells, and/or batteries. In accordance with at least certain embodiments, the present application is directed to novel or improved microporous membranes, battery separator membranes, separators, energy storage devices, batteries including such separators, methods of making such membranes, separators, and/or batteries, and/or methods of using such membranes, separators and/or batteries. In accordance with at least certain selected embodiments, the present invention is directed to a novel or improved separator membrane or separator with or without embedded particles or materials, such as ceramic particles or materials, for example, aluminum oxide, boehmite, and/or barium, and/or with or without novel polymers, such as PVDF or PMP, and/or with or without one or more ceramic coatings, for a battery which is stable up to at least 5 volts in a battery, a novel or improved polymer membrane, or polymeric microporous membrane, adapted for use in a 4.5 volt, 4.7 volt, or 5 volt or higher rechargeable or secondary lithium battery and/or which provides for the energy density of a battery to be increased and/or has excellent oxidation resistance. In accordance with at least particular embodiments, the battery separator membrane described herein is directed to a single or multilayer or composite microporous membrane battery separator which may have excellent oxidation resistance and/or may be stable in a high voltage lithium battery system up to 5 volts or more.

In accordance with at least selected embodiments, aspects or objects, the present disclosure or invention is directed to improved or novel separators, cells, batteries, and/or methods of manufacture and/or use. In accordance with at least certain embodiments, aspects or objects, the present disclosure or invention is directed to improved or novel separators such as a separator for a high energy and/or high voltage lithium ion battery which is stable above a 4.5 volt, 4.7 volt, or 5.0 volt or higher charging voltage, such as a novel or improved single or multilayer or ply microporous separator membrane.

In accordance with at least selected embodiments, the present application or invention is directed to novel or improved porous membranes or substrates, separator membranes, separators, composites, and/or the like for high voltage electrochemical devices, batteries, or cells, and/or methods of making such membranes or substrates, separators, cells, and/or batteries, and/or methods of using such membranes or substrates, separators, cells, and/or batteries.

In accordance with at least certain selected embodiments, the present invention is directed to a novel or improved separator membranes or battery separators which perform or are stable up to at least 5 volts in a high voltage battery. The membrane is preferably a novel or improved polymer membrane (optionally with embedded particles), or polymeric microporous membrane, adapted for use in a 5 volt lithium battery and/or which provides for the energy density of a battery to be increased and/or has excellent oxidation resistance. In accordance with at least particular embodiments, the battery separator membrane described herein is directed to a single or multilayer or composite microporous membrane battery separator which may have excellent oxidation resistance and/or may be stable in a high voltage battery system up to 5 volts or more stable in a high voltage battery system above 4.5 volts, 4.7 volts, 5 volts, or more.

In accordance with at least selected embodiments, aspects or objects, the present application or invention may address the above needs or issues, and/or may provide novel or improved or optimized embedded particle and/or novel polymer porous membranes or substrates, separator membranes, separators, composites, electrochemical devices, batteries, and/or methods of making such membranes or substrates, separators, and/or batteries, and/or methods of using such membranes or substrates, separators and/or batteries, particularly for such embedded particle and/or novel polymer porous membranes or substrates, separator membranes, separators, or composites which perform or are stable up to at least 5 volts in a battery.

The membrane is preferably a novel or improved polymer membrane, or polymeric microporous membrane, adapted for use in a 5 volt lithium battery and/or which provides for the energy density of a battery to be increased and/or has excellent oxidation resistance. In accordance with at least particular embodiments, the battery separator membrane described herein is directed to a single or multilayer or composite microporous PVDF and/or PMP membrane battery separator which may have excellent oxidation resistance and/or may be stable in a high voltage battery system up to 4.6 volts, 4.7 volts, 5 volts, or more.

In accordance with at least selected embodiments, aspects or objects, the present application or invention may address the above needs or issues, and/or may provide novel or improved separator membranes or separators for a battery which is stable up to at least 5 volts in a battery. The membrane is preferably a novel or improved polymer membrane, or polymeric microporous membrane, with or without embedded particles, adapted for use in a 5 volt lithium battery and/or which provides for the energy density of a battery to be increased and/or has excellent oxidation resistance. In accordance with at least particular embodiments, the battery separator membrane described herein is directed to a single or multilayer or composite microporous membrane battery separator which may have excellent oxidation resistance and/or may be stable in a high voltage battery system up to 4.7 volts, 5 volts, or more.

Celgard, LLC of Charlotte, N.C. is a leading innovator and manufacturer of lithium ion battery separator materials. As a leading separator manufacturer, Celgard holds a unique position in the lithium battery separator field. Through this position Celgard sees the advancement of the lithium battery industry toward a 5.0 volt (V) battery system.

As the lithium battery industry advances, previous gaps hindering a successful 5.0 V system have begun to close. For example, previous road blocks such as electrolyte performance have been improved enabling higher voltage cells. As individual battery component performance is improved, other system components emerge as constraining factors in pursuit of higher voltage cells. Lithium battery technology is now reaching voltages that are beginning to expose a limiting factor related to at least certain separators and specifically the oxidation stability of the separator materials in their newly designed working environment.

In accordance with at least one embodiment, this application is directed to a novel separator comprised of stable polymers in a 5.0 V system.

Celgard® brand polyolefin separators are typically thin, opaque, polypropylene (PP) and/or polyethylene (PE) electrolytic membranes fabricated as microporous monolayer or trilayer PP/PE/PP products (see FIG. 1). They are among the most highly engineered and critical components of lithium-ion batteries, providing a barrier between the anode and cathode while performing the core function of facilitating ion exchange.

Celgard separators, are engineered with the following features:

Uniform sub-micron pore structure with high chemical and thermal stability,

Excellent resistance to acids, bases, and other chemicals,

Monolayer and trilayer products in a variety of thicknesses and slit widths, and/or

Various proprietary technologies for hydrophobic or hydrophilic characteristics.

The preferred novel separators comprised of stable polymers in a 5.0 V system will preferably meet or exceed fundamental separator property requirements while advancing overall separator performance for the 5.0 V system, be a stable material for a 5.0 V lithium battery system, will have good mechanical, thermal and electrochemical characteristics, and/or good strength, shrinkage and porosity.

As the cell voltage increases, the oxidation stability of typical separator materials decreases and such oxidation of the separator material may contribute to the degradation of the cell performance over time. Therefore, in theory, to have a separator that will successfully work in a 5.0 volt lithium ion battery it is necessary to prevent oxidation (degradation) of the separator from occurring.

In accordance with certain embodiments, the separator membrane described herein is directed to a microporous battery separator membrane made of a 5 volt system stable polymer:

For example, the following resins or mixtures, blends or co-polymers thereof:

| | Symbol |
|---|---|
| High density polyethylene | HDPE |
| Isotactic polypropylene | iPP |
| UltrahighMW polyethylene | UHWPE |
| poly(4-methylpentene) | PMP |
| polyvinylidene flouride | PVdF |
| polyethylene terephthalate | PET |
| polyphenylene sulfide | PPS |
| Polyimide | PI |
| polybenzimidazol | PBI |
| polychlorotrifluoroethylene | PCTFE |
| polybenzimidazol + polyimide | PBI + PI |
| polyamide-66 | PA-66 |
| ethylenevinylalcohol copolymer | EVOH |
| polyoxymethylene | POM |
| Polysulfone | PS |

In accordance with at least selected embodiments, the present application is directed to a novel or improved 5.0 V system microporous battery separator membrane, separators, batteries including such separators, methods of making such membranes, separators, and/or batteries, and/or methods of using such membranes, separators and/or batteries. In accordance with at least certain embodiments, the present invention is directed to a battery separator for a primary or secondary battery.

In accordance with certain embodiments, the polymeric microporous membrane described herein is directed to a polymeric microporous membrane to which is applied a coating, ceramic coating, or the like on at least one side thereof.

### BRIEF DESCRIPTION OF THE FIGURES

FIG. 1 includes surface and cross-section SEM images of three Celgard® separator products.

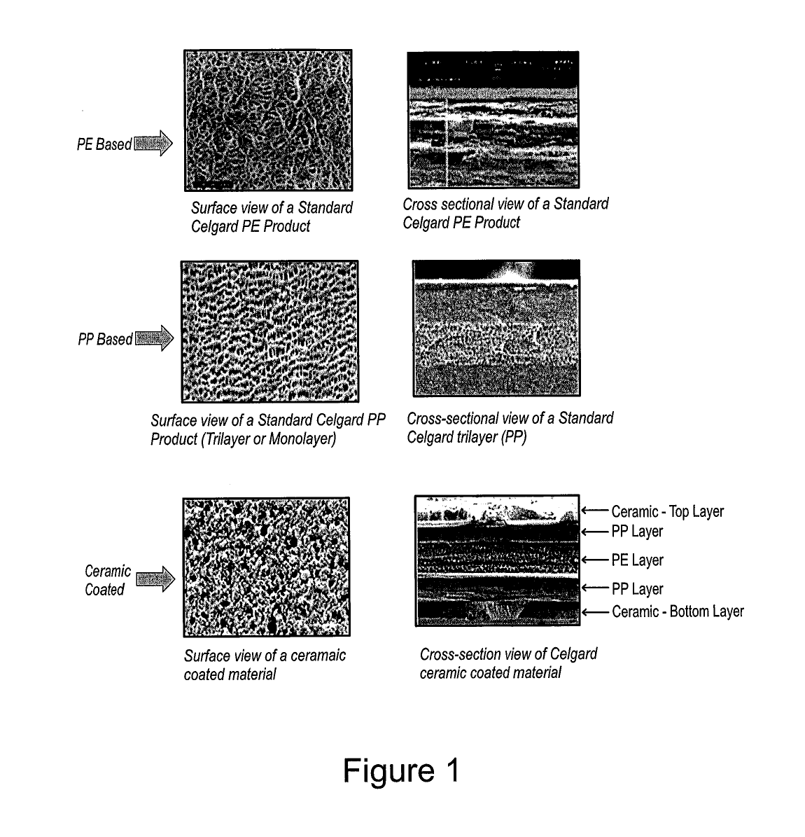

FIG. 2 is a surface SEM image of an exemplary inventive poly(4-methylpentene) (PMP) polymeric microporous membrane or film or separator.

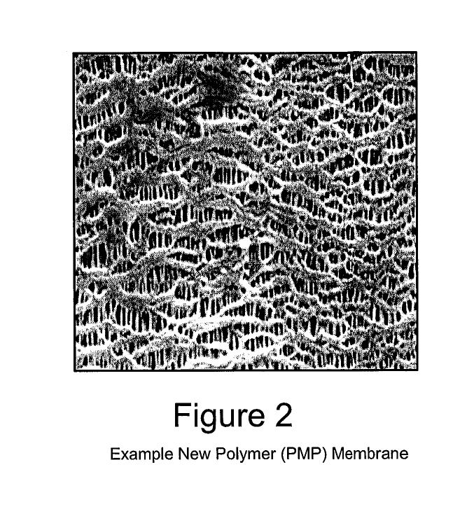

### DESCRIPTION OF THE INVENTION

In accordance with at least selected embodiments, aspects or objects, the present disclosure or invention is directed to improved or novel separators, cells, batteries, and/or methods of manufacture and/or use. In accordance with at least certain embodiments, aspects or objects, the present disclosure or invention is directed to improved or novel separators such as a separator for a high energy and/or high voltage lithium ion battery which is stable up to a 4.5 volt, or preferably up to a 5.0 volt or higher charging voltage, such as a novel or improved single or multilayer or ply microporous separator membrane.

In accordance with at least selected embodiments, the present application or invention is directed to novel or improved porous membranes or substrates, separator membranes, separators, composites, electrochemical devices, batteries, methods of making such membranes or substrates, separators, and/or batteries, and/or methods of using such membranes or substrates, separators and/or batteries. In accordance with at least certain embodiments, the present application is directed to novel or improved microporous membranes, battery separator membranes, separators, energy storage devices, batteries including such separators, methods of making such membranes, separators, and/or batteries, and/or methods of using such membranes, separators and/or batteries. In accordance with at least certain selected embodiments, the present invention is directed to a novel or improved separator membrane or separator for a battery which is stable up to at least 5 volts in a battery. The membrane is preferably a novel or improved polymer membrane, or polymeric microporous membrane, adapted for use in a 5 volt lithium battery and/or which provides for the energy density of a battery to be increased and/or has excellent oxidation resistance. In accordance with at least particular embodiments, the battery separator membrane described herein is directed to a single or multilayer or composite microporous membrane battery separator which may have excellent oxidation resistance and/or may be stable in a high voltage battery system up to 5 volts or more.

A widely adopted approach to increasing the cell energy level of a lithium ion rechargeable battery is to increase charging voltage in order to increase the overall energy density of a battery cell. The inventive separator membrane preferably may include or consist of a thermal shutdown membrane with high temperature thermal stability which is designed to increase the overall energy density of a high energy lithium ion battery. The inventive microporous separator membrane is preferably a next generation technology polymer separator membrane which uses a novel polymer and/or embedded ceramic material to achieve a 5 volt charging voltage capability in a lithium ion rechargeable battery. Furthermore, the inventive microporous separator membrane preferably supports the future development trend towards a high energy battery for consumer electronic applications and for a high energy battery lithium ion battery capable of achieving an extended driving range in electric vehicle applications.

The invention may also address the need for a polymeric microporous separator membrane with an oxidation stability at 5 volts for use in a lithium ion rechargeable battery. The inventive microporous separator membrane is preferably a next generation technology polymer separator membrane which uses a novel embedded ceramic material to achieve a 5 volt charging voltage capability in a lithium ion rechargeable battery. Furthermore, the inventive microporous separator membrane is more preferably a next generation technology non-polyolefin separator membrane which uses a novel embedded ceramic material to achieve oxidation stability at a 5 volt charging voltage in a lithium ion rechargeable battery.

One vital component in achieving a 5 volt charging voltage capability is the battery separator membrane. Traditional existing separator materials such as polyolefin are currently being used as a battery separator membrane in a 4.2 to 4.5 volt lithium ion rechargeable battery. Preferably, a polyolefin separator such as a polypropylene microporous separator membrane with a thermal shutdown function and thermally stability up to 165° C. is used as a battery separator membrane in a 4.2 to 4.5 volt lithium ion rechargeable battery. More preferably, a polyolefin separator with a ceramic coating or layer such as that described in U.S. Pat. No. 6,432,586 (incorporated by reference herein) which has a thermal shutdown function and high temperatures stability up to 180° C. is used in a 4.2 to 4.5 volt lithium ion rechargeable battery.

The present invention is possibly preferably embodied in a microporous separator membrane for a high energy lithium ion battery which is stable up to a 5 volt charging voltage. The inventive separator membrane is possibly preferably embodied in a separator or membrane that consists of a thermal shutdown membrane with high temperature thermal stability which is designed to increase the overall energy density of a high energy lithium ion battery. The inventive microporous separator membrane is preferably a next generation technology polymer separator membrane which uses a novel embedded ceramic material to achieve a 5 volt charging voltage capability in a lithium ion rechargeable battery.

A battery cell which has a 5 volt charging voltage capability can be charged to a higher level to allow for additional energy density. One vital component in achieving a 5 volt charging voltage capability is the battery separator membrane. Traditional existing separator materials such as polyolefin may be currently be used as a battery separator membrane in a 4.2 to 4.5 volt lithium ion rechargeable battery. Preferably, an inventive polyolefin separator such as a polypropylene microporous separator membrane with a thermal shutdown function and thermally stability up to 165° C. is used as a battery separator membrane in a 4.2 to 4.5 volt lithium ion rechargeable battery. More preferably, an inventive polyolefin separator with a ceramic coating or layer such as that described in U.S. Pat. No. 6,432,586 which has a thermal shutdown function and high temperatures stability up to 180° C. is used in a 4.2 to 4.5 volt lithium ion rechargeable battery.

Furthermore, the inventive separator membrane is preferably a polyolefin separator membrane which uses a novel embedded ceramic material to achieve a 5 volt charging voltage capability in a lithium ion rechargeable battery. In addition, the inventive separator membrane is a non-polyolefin separator membrane which uses a novel embedded ceramic material to achieve a 5 volt charging voltage capability in a lithium ion rechargeable battery.

Furthermore, the possibly preferred inventive microporous separator membrane supports the future development trend towards a high energy battery for consumer electronic applications and for a high energy battery lithium ion battery capable of achieving an extended driving range in electric vehicle applications.

The present invention is possibly preferably a microporous separator membrane for a high energy lithium ion battery which is stable up to a 5 volt charging voltage.

In accordance with at least selected embodiments, aspects or objects, the present disclosure or invention is directed to improved or novel separators, cells, batteries, and/or methods of manufacture and/or use. In accordance with at least certain embodiments, aspects or objects, the present disclosure or invention is directed to improved or novel separators such as a separator for a high energy and/or high voltage lithium ion battery which is stable up to a 4.5 volt, or preferably up to a 5.0 volt or higher charging voltage, such as a novel or improved single or multilayer or ply microporous separator membrane.

The present invention is possibly preferably a microporous separator membrane for a high energy rechargeable lithium battery and which is sufficiently stable or performing in the battery during the specified, stated or intended number of repetitive charge-discharge cycles of the rechargeable battery. It is reasonable to consider the performance of the separator in the context of what would result in a 5 volt rechargeable lithium battery that could remain effective throughout repetitive charge-discharge cycling during use. As such, the separator should perform or function during the specified, stated or intended number of repetitive charge-discharge cycles of a rechargeable battery (during the reasonable lifetime of a particular battery). The preferred separator should prevent shorts caused by touching of the anode to the cathode, catastrophic hard shorts of the battery, thermal runaway of the battery, or a serious safety problem for the battery throughout the repetitive charge-discharge cycling during use of the battery (that would result in a useful rechargeable battery that could remain effective throughout the type of repetitive charge-discharge cycling, that would be fully effective at least for the expected number of charging cycles for a given battery application, rechargeable batteries in general are typically understood in terms of cycle life (“cycle life” for rechargeable batteries, including lithium-ion batteries, may be defined as “the number of cycles, consisting of a discharge, a charge, and rest periods, under specified conditions, that a rechargeable battery can undergo before failing to meet its specified end-of-life capacity or voltage under load.”)

In accordance with at least selected embodiments, aspects or objects, the present disclosure or invention is directed to improved or novel separators, cells, batteries, and/or methods of manufacture and/or use. In accordance with at least certain embodiments, aspects or objects, the present disclosure or invention is directed to improved or novel separators such as a separator for a high energy and/or high voltage lithium ion battery which is stable up to a 4.5 volt, or preferably up to a 5.0 volt or higher charging voltage, such as a novel or improved single or multilayer or ply microporous separator membrane.

In accordance with at least selected embodiments, the present application or invention is directed to novel or improved porous membranes or substrates, separator membranes, separators, composites, electrochemical devices, batteries, methods of making such membranes or substrates, separators, and/or batteries, and/or methods of using such membranes or substrates, separators and/or batteries. In accordance with at least certain embodiments, the present application is directed to novel or improved microporous membranes, battery separator membranes, separators, energy storage devices, batteries including such separators, methods of making such membranes, separators, and/or batteries, and/or methods of using such membranes, separators and/or batteries. In accordance with at least certain selected embodiments, the present invention is directed to a novel or improved separator membrane or separator for a battery which is stable up to at least 5 volts in a battery. The membrane is preferably a novel or improved polymer membrane, or polymeric microporous membrane, adapted for use in a 5 volt lithium battery and/or which provides for the energy density of a battery to be increased and/or has excellent oxidation resistance. In accordance with at least particular embodiments, the battery separator membrane described herein is directed to a single or multilayer or composite microporous membrane battery separator which may have excellent oxidation resistance and/or may be stable in a high voltage battery system up to 5 volts or more stable in a high voltage battery system up to 4.5 volts, 4.7 volts, 5 volts, or more.

In accordance with at least selected embodiments, aspects or objects, the present application or invention may address the above needs or issues, and/or may provide novel or improved porous membranes or substrates, separator membranes, separators, composites, electrochemical devices, batteries, methods of making such membranes or substrates, separators, and/or batteries, and/or methods of using such membranes or substrates, separators and/or batteries. In accordance with at least certain embodiments, the present application is directed to novel or improved microporous membranes, battery separator membranes, separators, energy storage devices, batteries including such separators, methods of making such membranes, separators, and/or batteries, and/or methods of using such membranes, separators and/or batteries. In accordance with at least certain selected embodiments, the present invention is directed to a novel or improved separator membrane or separator for a battery which is stable up to at least 5 volts in a battery. The membrane is preferably a novel or improved polymer membrane, or polymeric microporous membrane, adapted for use in a 5 volt lithium battery and/or which provides for the energy density of a battery to be increased and/or has excellent oxidation resistance. In accordance with at least particular embodiments, the battery separator membrane described herein is directed to a single or multilayer or composite microporous membrane battery separator which may have excellent oxidation resistance and/or may be stable in a high voltage battery system up to 5 volts or more stable in a high voltage battery system up to 4.5 volts, 4.7 volts, 5 volts, or more.

TABLE 1

| | |
|---|---|
| Current Tech: | Advanced Products: |
| High Temperature Melt | 5.0 V Stable |
| Integrity | Novel High Voltage Polymers |
| Binder and Solvent Based | Single Layer Polymers |
| Ceramic Coatings | Multilayer Constructions |
| 2 to 3 μm coating thickness | |

In accordance with certain embodiments, the separator membrane described herein is directed to a microporous battery separator membrane made of a 5 volt system stable polymer:

For example, the following resins or mixtures, blends or co-polymers thereof:

Preferably having a Tm over 200 deg C. and/or a Tg over 250 deg C.:

| | Symbol |
|---|---|
| High density polyethylene | HDPE |
| Isotactic polypropylene | iPP |
| UltrahighMW polyethylene | UHWPE |
| poly(4-methylpentene) | PMP |
| polyvinylidene flouride | PVdF |
| polyethylene terephthalate | PET |
| polyphenylene sulfide | PPS |
| Polyimide | PI |
| polybenzimidazol | PBI |
| polychlorotrifluoroethylene | PCTFE |
| polybenzimidazol + polyimide | PBI + PI |
| polyamide-66 | PA-66 |
| ethylenevinylalcohol copolymer | EVOH |
| polyoxymethylene | POM |
| Polysulfone | PS |

In accordance with at least selected embodiments, the present application is directed to a novel or improved microporous battery separator membrane, separators, batteries including such separators, methods of making such membranes, separators, and/or batteries, and/or methods of using such membranes, separators and/or batteries. In accordance with at least certain embodiments, the present invention is directed to a battery separator for a primary or secondary battery.

In accordance with certain embodiments, the polymeric microporous membrane described herein is directed to a polymeric microporous membrane to which is applied a coating, ceramic coating, or the like.

In accordance with at least selected embodiments, the present application or invention is directed to novel or improved porous membranes or substrates, separator membranes, separators, composites, electrochemical devices, batteries, methods of making such membranes or substrates, separators, and/or batteries, and/or methods of using such membranes or substrates, separators and/or batteries. In accordance with at least certain embodiments, the present application is directed to novel or improved microporous membranes, battery separator membranes, separators, energy storage devices, batteries including such separators, methods of making such membranes, separators, and/or batteries, and/or methods of using such membranes, separators and/or batteries. In accordance with at least certain selected embodiments, the present invention is directed to a novel or improved separator membrane or separator for a battery which is stable up to at least 5 volts in a battery. The membrane is preferably a novel or improved polymer membrane, or polymeric microporous membrane, adapted for use in a 5 volt lithium battery and/or which provides for the energy density of a battery to be increased and/or has excellent oxidation resistance. In accordance with at least particular embodiments, the battery separator membrane described herein is directed to a single or multilayer or composite microporous membrane battery separator which may have excellent oxidation resistance and/or may be stable in a high voltage battery system up to 5 volts or more, or stable in a high voltage battery system up to 4.5 volts, 4.7 volts, 5 volts, or more.

The novel or improved separator membrane or separator with embedded particles or materials, such as ceramic particles or materials, for example, aluminum oxide, boehmite, barium, and/or barium sulfate, may also have novel polymers, such as PVDF or PMP, and/or one or more ceramic coatings. The preferred embedded particles may be selected from one or more of: particles or materials, ceramic particles or materials, aluminum oxide, boehmite, barium, and/or barium sulfate, x-ray detectable elements, metal, metal oxide, metal phosphate, metal carbonate, X-ray fluorescent material, metal salt, metal sulfate, or mixtures thereof, any of the foregoing metals being selected from the group consisting of Zn, Ti, Mn, Ba, Ni, W, Hg, Si, Cs, Sr, Ca, Rb, Ta, Zr, Al, Pb, Sn, Sb, Cu, Fe, and/or combinations, blends or mixtures thereof.

In accordance with at least selected In accordance with at least selected embodiments, aspects or objects, the present disclosure or invention is embodiments, the present disclosure or invention is directed to improved or novel separators, cells, batteries, and/or methods of manufacture and/or use. In accordance with at least certain embodiments, the present disclosure or invention is directed to improved or novel separators such as a separator for a high energy and/or high voltage lithium ion battery which is stable up to a 4.5 volt, or preferably up to a 5.0 volt or higher charging voltage, such as a novel or improved single or multilayer or multiply microporous separator membrane. In accordance with at least selected embodiments, the present application or invention is directed to novel or improved porous membranes or substrates, separator membranes, separators, composites, electrochemical devices, batteries, cells, methods of making such membranes or substrates, separators, cells, and/or batteries, and/or methods of using such membranes or substrates, separators, cells, and/or batteries. In accordance with at least certain embodiments, the present application is directed to novel or improved microporous membranes, battery separator membranes, separators, energy storage devices, batteries including such separators, methods of making such membranes, separators, and/or batteries, and/or methods of using such membranes, separators and/or batteries. In accordance with at least certain selected embodiments, the present invention is directed to a novel or improved separator membrane or separator with or without embedded particles or materials, such as ceramic particles or materials, for example, aluminum oxide, boehmite, barium, and/or barium sulfate, and/or with or without novel polymers, such as PVDF or PMP, and/or with or without one or more ceramic coatings, for a battery which is stable up to at least 5 volts in a battery, a novel or improved polymer membrane, or polymeric microporous membrane, adapted for use in a 4.5 volt, 4.7 volt, or 5 volt or higher rechargeable or secondary lithium battery and/or which provides for the energy density of a battery to be increased and/or has excellent oxidation resistance. In accordance with at least particular embodiments, the battery separator membrane described herein is directed to a single or multilayer or composite microporous membrane battery separator which may have excellent oxidation resistance and/or may be stable in a high voltage lithium battery system up to 5 volts or more.

The present invention may be embodied in other forms without departing from the spirit and the essential attributes thereof, and, accordingly, reference should be made to the appended claims, rather than to the foregoing specification, as indicating the scope of the invention. Additionally, the invention disclosed herein suitably may be practiced in the absence of any element which is not specifically disclosed herein.

We claim:

1) Improved or novel membranes or separators for a high energy and/or high voltage rechargeable lithium battery which is stable over 4.5 volts and comprises at least one porous membrane comprising at least one of embedded particles, a novel polymer, and a ceramic coating on at least one side.

2) The membrane of claim 1 being stable up to at least 4.6 volts.

3) The membrane of claim 1 being stable up to at least 4.7 volts.

4) The membrane of claim 1 being stable up to at least 5.0 volts.

5) The membrane of claim 1 being stable up to up to a 5.0 volt or higher charging voltage.

6) The membrane of claim 1 being a novel or improved single or multilayer or multiply microporous separator membrane.

7) The membrane of claim 1 being at least one of a microporous separator membrane for a high energy lithium ion battery which is stable up to a 5 volt charging voltage, a thermal shutdown membrane with high temperature thermal stability which is designed to facilitate an increase in the overall energy density of a high energy lithium ion battery, a polymer separator membrane which uses a novel embedded ceramic material to achieve a 5 volt charging voltage capability in a lithium ion rechargeable battery, and a microporous separator membrane that supports the future development trend towards a high energy battery for consumer electronic applications or for a high energy battery lithium ion battery capable of achieving an extended driving range in electric vehicle applications.

8) The membrane of claim 1 being a microporous battery separator membrane comprising a polymer containing an embedded ceramic material whereby the ceramic-containing polymer microporous battery separator membrane has a 5 volt charging voltage capability in a lithium ion rechargeable battery.

9) The membrane of claim 8 being a polyolefin microporous battery separator membrane.

10) The membrane of claim 8 being a non-polyolefin microporous battery separator membrane.

11) The membrane of claim 8 wherein said polymer microporous battery separator membrane has a thermal shutdown function.

12) The membrane of claim 11 wherein said polymer microporous battery separator membrane has a high temperature stability up to 165° C.

13) The membrane of claim 12 wherein said polymer microporous battery separator membrane has a high temperature stability up to 180° C.

14) The membrane of claim 13 wherein said polymer microporous battery separator membrane has a high temperature stability ≧180° C.

15) The membrane of claim 8 wherein the microporous battery separator membrane has greater than or equal to a 5 volt charging voltage capability in a lithium ion rechargeable battery.

16) In a rechargeable lithium battery, the improvement comprising the microporous battery separator membrane of claim 8.

17) In an electric drive vehicle, the improvement comprising the microporous battery separator membrane of claim 8.

18) The membrane of claim 8 wherein the embedded ceramic material is selected from the group of ceramic particles, aluminum oxide, boehmite, barium, barium sulfate, X-ray detectable elements, metal, metal oxide, metal phosphate, metal carbonate, X-ray fluorescent material, metal salt, metal sulfate, or mixtures thereof, and any of the foregoing metals being selected from the group consisting of Zn, Ti, Mn, Ba, Ni, W, Hg, Si, Cs, Sr, Ca, Rb, Ta, Zr, Al, Pb, Sn, Sb, Cu, Fe, and mixtures thereof.

19) A non-polyolefin microporous battery separator membrane which consists of one or more non-polyolefin polymers and which has a oxidation stability at a 5 volt charge voltage in a lithium rechargeable battery.

20) The membrane of claim 19 wherein said membrane is used as a component of an electrochemical device, a capacitor, a super capacitor, a double layer capacitor, a primary battery, or a secondary battery.

21) The membrane of claim 1 wherein said membrane is a lithium secondary battery separator that is stable against oxidation in a lithium ion battery with a cell voltage up to or equal to 5.0 volts, wherein cell voltage may be a measure of the potential difference between two electrodes (positive electrode and negative electrode) in an electrochemical cell.
